(19) United States
(12) Patent Application Publication
(10) Pub. No.: US 2024/0372880 A1
(43) Pub. Date: Nov. 7, 2024

(54) MONITORING AND CONTROL OF NETWORK TRAFFIC IN A CLOUD SERVER ENVIRONMENT

(71) Applicant: Salesforce, Inc., San Francisco, CA (US)

(72) Inventors: Kaushal Bansal, Pleasanton, CA (US); Alankar Sharma, Moorestown, NJ (US); Prabhat Singh, San Jose, CA (US)

(21) Appl. No.: 18/143,197

(22) Filed: May 4, 2023

(51) Int. Cl. H04L 9/40

(52) U.S. Cl. CPC H04L 63/1425; H04L 63/1416; H04L 63/20

(57) ABSTRACT

A computer-implemented method for monitoring and control of a network traffic in a cloud server environment is disclosed. The method includes receiving network traffic at a cloud service account that includes a corresponding local security enforcement module configured to enforce security policies for data processed by the cloud service account and forwarding a part of the network traffic from the cloud service account to a centralized security monitoring hub that includes a hardware-based security component. The method also includes detecting, by the hardware-based security component, offending traffic that includes traffic from an unwanted source or with malicious content. The method further includes sending a notification of the offending traffic to the localized security enforcement module, by the centralized security monitoring hub, and responsive to the notification, implementing a security enforcement strategy in the cloud service account based on the security policy, by the corresponding localized security enforcement module.

### BACKGROUND

The present disclosure relates generally to detecting offending traffic in cloud service accounts. The offending traffic may come from an unwanted source or may be one with malicious content. Traditionally, network security is enforced in a centralized mode, where all traffic flow through a central location and are inspected by a centralized mechanism. In a developer-centric deployment mode, however, this approach may be difficult to manage and scale. Existing fully centralized monitoring and control may slow down overall performance of the system. The problem of offending traffic detection becomes harder to address as cloud service providers scale up their operations.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description explain the principles of implementations of the disclosed subject matter. No attempt is made to show structural details in more detail than can be necessary for a fundamental understanding of the disclosed subject matter and various ways in which it can be practiced.

FIG. 1 is a block diagram illustrating an example system for monitoring and control of network traffic in a cloud server network.

FIG. 2A is a flow diagram illustrating a method for monitoring and control of network traffic of the system of FIG. 1.

FIG. 2B is a flow diagram illustrating a method for monitoring and control of network traffic of the system of FIG. 1.

FIG. 3A is a block diagram illustrating an exemplary electronic device according to an example implementation.

FIG. 3B is a block diagram of an exemplary deployment environment according to an example implementation.

### DETAILED DESCRIPTION

Various aspects or features of this disclosure are described with reference to the drawings, wherein like reference numerals are used to refer to like elements throughout. In this specification, numerous details are set forth in order to provide a thorough understanding of this disclosure. It should be understood, however, that certain aspects of disclosure can be practiced without these specific details, or with other methods, components, materials, or the like. In other instances, well-known structures and devices are shown in block diagram form to facilitate describing the subject disclosure.

Embodiments of the present disclosure provide a hybrid architecture including security monitoring in a centralized mode and security enforcement in a distributed mode. The hybrid architecture includes a number of localized security enforcement modules that enforce security policies in corresponding cloud service accounts. Further, there is a centralized security monitoring hub communicably coupled with the localized security enforcement modules. The centralized security monitoring hub includes hardware security components that monitor and analyze the network traffic and generate the security policies. The hardware security components typically possess a scale-up architecture associated with high computational and memory capacity and they provide high throughput and low latency inspection capabilities. One or more hardware devices may be used at the centralized security monitoring hub to reduce processing time and latency, compared to software-based analysis. This solution provides a balance of the scalability and performance of a centralized security model and the flexibility of a distributed model.

The enhanced hardware-based security model of the present disclosure allows for security of network traffic across multiple environments built over multiple cloud computing substrates, such as Amazon Web Service (AWS), Google Cloud Platform (GCP), Microsoft Azure, and the like. This security model enables an augmented layer of security controls and testing activities, as early as possible, in a large-scale distributed software development life cycle (SDLC) of cloud-based applications and services. Consequently, potential security vulnerabilities and threats are identified and addressed early on in the software development process, reducing the risk of serious security breaches and data loss in production, while still taking advantage of improved processing time and efficiency available in hardware-based security devices.

In an aspect of the disclosed subject matter, a computer-implemented method is disclosed for monitoring and control of a network traffic in a cloud server environment. The computer-implemented method may include receiving network traffic at a cloud service account that includes a corresponding local security enforcement module configured to enforce security policies for data processed by the cloud service account. The computer-implemented method may also include forwarding at least a part of the network traffic from the cloud service account to a centralized security monitoring hub, by the localized security enforcement modules. The centralized security monitoring hub includes a hardware-based security component. The computer-implemented method may also include detecting, by the hardware-based security component, offending traffic in the part of the network traffic. The offending traffic includes traffic from an unwanted source or with malicious content. The computer-implemented method may further include responsive to the offending traffic, sending a notification of the offending traffic to the corresponding localized security enforcement module, by the centralized security monitoring hub, and responsive to the notification, implementing a security enforcement strategy in the cloud service account based on the security policy, by the corresponding localized security enforcement module.

The computer-implemented method may further include storing data from at least a part of the forwarded network traffic at a data repository communicably coupled with the centralized security monitoring hub and generating the security policy based on analysis of the stored network traffic data, source reputation information from external tenants, or a combination thereof.

The computer-implemented method may further include constructing flow state tables corresponding to the localized security enforcement modules based on the data from at least a part of the forwarded network traffic and sending the flow state tables to the corresponding localized security enforcement modules, by the centralized security monitoring hub. The computer-implemented method may also include implementing a network traffic short-circuit mechanism at the service accounts based on the flow state tables, by the localized security enforcement modules, the network traffic short-circuit mechanism configured to change an inline mode of the network traffic to an out-of-band mode.

The computer-implemented method may further include daisy chaining the localized security enforcement module and the hardware-based security component in a chain. The computer-implemented method may further include daisy chaining at least one other hardware-based security component of the centralized security monitoring hub in the chain.

In an aspect of the disclosed subject matter, a system is disclosed for monitoring and control of a network traffic in a cloud server environment. The system may include one or more computer processors and a cloud server application digitally connected with the computer processors. The cloud server application may include a centralized security monitoring hub including hardware-based security components and service accounts including local security enforcement modules. The system may also include a non-transitory machine-readable storage medium that provides instructions that are configurable to cause the system to perform any of the methods disclosed herein.

In an aspect of the disclosed subject matter, a non-transitory machine-readable storage medium is disclosed that includes instructions that, if executed by a processor, are configurable to cause said processor to perform operations and methods for monitoring and control of a network traffic in a cloud server environment.

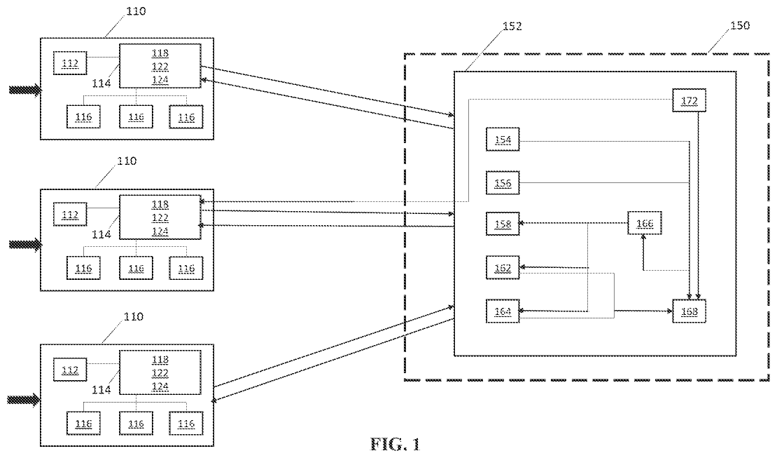

FIG. 1 is a block diagram illustrating a system 100 for monitoring and control of a network traffic in a cloud server environment. The system 100 includes cloud service accounts 110 that receive network traffic at corresponding ingress zones 112. An ingress zone is typically a cloud-native network component such as an Internet Gateway (IGW), a Network Address Translation Gateway (NAT GW) or a load balancer that exposes a private infrastructure associated with the cloud service to the Internet with a public internet protocol (IP) address and provides a perimeter for networking and security related configurations. The ingress zones 112 may include network resources, such as virtual machines, subnets, or network interfaces, that share common security policies and access controls. The ingress zones 112 are integrated with corresponding local security enforcement modules 114 configured to enforce security policies for data processed by a number of workloads 116. The workloads 116 may be specific applications, processes, or services running on the cloud server or virtual machines. The workloads 116 may include various components, such as the operating system, web servers, application servers, database servers, or storage servers, application software, libraries, and data used by each account 110. The workloads 116 are monitored and controlled to provide consistent performance, availability, and security of the entire cloud environment.

The security enforcement modules 114 are placed at various physical locations throughout the network and they implement a distributed network-based security architecture that enforces security functions across multiple locations or devices, monitors the network traffic generated by the workloads 116, identifies potential security threats, and ensures that the workloads 116 are properly utilized. The security enforcement modules 114 may be operationalized using various network devices, such as firewalls, intrusion detection and prevention systems, or cloud-based security solutions, such as cloud-based firewalls or endpoint security services. By distributing and localizing the security enforcement modules 114, tenants with large networks may protect against security threats while minimizing single points of failure, processing overhead and network latency.

Latency, in the context of network traffic, refers to the amount of time taken for data to travel from a server to a client over a network. Latency may be caused by a variety of factors including network congestion, geographical distance between the client and the server. the number of network hops that the data must pass through, processing time required by the server to respond to a request and the like. Typically measured in milliseconds (ms) or microseconds (μs), latency is an important metric to monitor for applications that require real-time interactions and experiences. Various techniques, such as reducing the number of network hops, implementing Quality of Service (QOS) policies to prioritize certain types of traffic, using Content Delivery Networks (CDNs) to cache and serve content closer to the client are used to minimize network latency.

Referring to FIG. 1, the security enforcement modules 114 may include traffic monitoring modules 118. A traffic monitoring module is a software or hardware component used to monitor and analyze network traffic in real-time and provide visibility into the traffic flow, identify potential security threats, and optimize network performance by using techniques. such as deep packet inspection (DPI), flow analysis, log analysis and the like. The traffic monitoring modules 118 gather and analyze data on network traffic, including the volume, source, destination, and content of the traffic. This data may be used to identify trends, detect anomalies, and troubleshoot network performance issues.

The security enforcement modules 114 may include flow state tables 122 constructed based on the data related to the network traffic. A flow state table is a data structure used by network devices to track and manage information about active network connections, such as IP addresses, ports, packet counters, and hash of the packet headers. The information stored in a flow state table may be used to implement traffic management policies, such as Quality of Service (QOS) and bandwidth shaping.

The security enforcement modules 114 may implement a network traffic short-circuiting mechanism in conjunction with the flow state tables 122 to change the processing mode of a flow once it has been determined to be trusted. In a typical network, packets are processed sequentially through a series of network devices, such as routers, switches, and firewalls while the network devices perform their own set of processing tasks on the packet, that may include filtering, routing, and inspection for security threats. A typical network traffic short-circuiting mechanism may work by changing the processing mode from in-line to out-of-band, where the packets are sent to a separate processing path that does not involve the same level of inspection. Another approach may be to use the flow state tables 122 to determine that a packet belongs to a flow that has already been processed and does not require further processing. In this case, bypassing several processing steps, the packet may be forwarded to its destination. Using network traffic short-circuiting mechanism may allow highly dynamic and unpredictable traffic to be processed more efficiently and quickly, potentially with low latency.

The security enforcement modules 122 may include flow filtering modules 124 that are software or hardware components used to filter and control the flow of network traffic. Flow filtering modules 124 are designed to selectively allow or block traffic based on predefined criteria, such as source and destination IP addresses, port numbers, protocols, or specific applications and these may use access control lists (ACLs), firewalls, and security groups to filter and control traffic and help tenants protect their critical assets, maintain compliance with regulatory requirements, and optimize network performance and latency.

Referring back to FIG. 1, at least a part of the network traffic from the cloud service accounts 110 may be forwarded to a centralized security monitoring hub 150 by the security enforcement modules 114. In one embodiment, the original destinations of the network traffic packets may be modified and the packets may be tunneled, using Virtual Private Network (VPN) technologies, to the centralized security monitoring hub 150. This method of network traffic diversion is typically associated with high performance. At times, however, there may be loss of information from the original packets and it may not be always transparent what information is lost and to what extent. In another embodiment, the original network traffic packets may be preserved and an overlay networking technology such as Virtual Extensible Local Area Network (VXLAN) or Generic Network Virtualization Encapsulation (GENEVE) may be used to forward the network traffic to the centralized security monitoring hub 150. This method of traffic diversion is usually more expensive due to encapsulation or decapsulation of the original network traffic packets. Further, performance and quality related details such as loss of information during transition of the network traffic are transparent.

The centralized security monitoring hub 150 consolidates and centralizes security monitoring and control functions in a single location or device in a cloud computing environment and is responsible for monitoring and analyzing all network traffic for potential security threats, such as malware, viruses, and unauthorized access attempts. The benefits of a centralized security monitoring hub 150 may include improved network security, increased visibility into network traffic, and centralized control over security policies and configurations. In addition to providing faster processing of traffic, the centralized security monitoring hub 150 may also collect network flows and build intelligence on them. This may help tenants to better understand the traffic patterns on their network and identify potential security threats. The centralized security monitoring hub 150 may also help build automated response mechanisms based on behavior and performance of the users and the systems.

The centralized security monitoring hub 150 may include one or more hardware-based security components 152, such as custom, dedicated, or single-purpose hardware components that analyze and process network traffic at the hardware level, including the example devices disclosed in further detail below. The hub 150 may be physically located remotely from the hardware that provides other aspects of the cloud services hosting the accounts 110, or a hub 150 may be placed at centralized physical locations for each cloud service, such as within a data center operated by the cloud service. The hardware-based security component 152 may detect offending traffic in the part of the network traffic. The offending traffic may include traffic from an unwanted source or with malicious content. Responsive to the offending traffic the centralized security monitoring hub 150 may send a notification of the offending traffic to the corresponding localized security enforcement module 114. Responsive to the notification, the corresponding localized security enforcement module 114 may implement a suitable security enforcement strategy in the cloud service account 110 based on the security policy.

For example, IP allowlisting (also known as IP whitelisting) and IP blocklisting (also known as IP blacklisting) are network security enforcement strategies used to control access to a cloud server network. IP allowlisting typically creates a list of authenticated IP addresses and configures network security devices, such as firewalls or routers, to allow traffic only from the authenticated IP addresses. IP blocklisting creates a list of blocked IP addresses and configures network security devices to prevent access from known malicious IP addresses or to block traffic from countries or regions that are known to be sources of malicious traffic.

Referring back to FIG. 1, the hardware-based security component 152 may include a layer 3 or layer 4 filtering module 154, a rate limiting module 156, a IDS (Intrusion Detection System), IPS (Intrusion Prevention System), WAF (Web Application Firewall) module 158, a BOT management module 162, a layer 7 Inspection module 164, NDR (Network Detection and Response) solution module 166, a network flow data repository 168, and/or an IP address credit score system 172 for fast processing of network traffic. Any combination of such devices may be used, and other dedicated hardware devices may be used.

Layer 3 or layer 4 filtering modules 154 may include network security components that operate at the network layer (layer 3) or transport layer (layer 4) of an Open Systems Interconnection (OSI) model and are responsible for handling IP addressing, routing, and packet transmission. A Layer 3 or layer 4 filtering module typically works by examining network traffic and applying rules to allow or block traffic based on various criteria, such as source and destination IP addresses, port numbers, and protocol types. Layer 3 or layer 4 filtering is also known as access control lists (ACLs) or packet filtering. By filtering traffic at the network or transport layer, layer 3 or 4 filtering modules 154 may provide basic protection against certain types of network attacks, such as denial-of-service (DOS) attacks or IP spoofing.

Rate limiting modules 156 may include network security components that control the amount of network traffic that may pass through a particular network interface or port. Rate limiting modules 156 may be used to limit the rate of incoming or outgoing traffic to prevent overload or abuse of network resources. Rate limiting modules 156 typically work by setting a maximum rate at which traffic may be sent or received. Any traffic that exceeds this rate is either dropped or queued for later processing. Rate limiting modules 156 may be useful for controlling traffic flows and preventing certain types of network attacks, such as denial-of-service (DOS) attacks or brute force attacks. Further, rate limiting modules 156 may be used to control the amount of traffic that is allowed to flow to or from virtual machines or containers. This may help to prevent resource contention and ensure that each application or service running in the cloud network has access to the necessary resources to operate efficiently.

IDS-IPS-WAF modules 158 may include network security components that monitor network traffic for suspicious activities and potential security threats. IDS functions typically analyze the network traffic in real-time and generates alerts when it detects any anomalies or patterns that indicate a potential security breach. IPS functions operate in conjunction with IDS functions to prevent potential security threats from compromising a network. IPS functions may automatically take actions to block or prevent any suspicious activities identified by the IDS functions. WAF functions are a type of firewall that is specifically designed to protect web applications from various types of attacks, including SQL injection, cross-site scripting, and other application-level attacks. WAF functions monitor the traffic between web applications and the internet, and they may block or filter any malicious traffic that tries to exploit vulnerabilities in the application. In operation, IDS, IPS, and WAF functions form comprehensive network security strategy. They work together to monitor and control network traffic, detect potential security threats, and prevent attackers from exploiting vulnerabilities in the network.

BOT management modules 162 may include network security components used to monitor and control BOTs (short forms for “robots”) that are automated scripts or programs designed to perform specific tasks on a network. BOTs may be used for web crawling or monitoring, but they may also be used for malicious activities, such as distributed denial-of-service (DDOS) attacks, credential stuffing, or spamming. BOT management modules 162 are designed to identify and mitigate malicious BOTs in a cloud server network using various techniques, such as signature-based detection, behavioral analysis, or machine learning algorithms. Once identified, the BOT management modules 162 may take actions to mitigate the impact of malicious BOTs, such as blocking traffic, redirecting traffic to honeypots, or throttling traffic.

Layer 7 inspection modules 164 may include network security modules that operate at the application layer (layer 7) of an Open Systems Interconnection (OSI) model. As is known in the network security art, layer 7 is responsible for handling application-specific protocols, such as HTTP, FTP, SMTP, and other protocols. Layer 7 inspection modules 164 work by examining network traffic at the application layer and applying rules to allow or block traffic based on various criteria, such as URL filtering, file type blocking, and user agent blocking. This type of filtering is also known as application filtering or deep packet inspection (DPI). By filtering traffic at the application layer, layer 7 inspection modules 164 may provide comprehensive protection against advanced threats that use application-specific vulnerabilities or exploits, such as SQL injection or cross-site scripting (XSS) attacks.

NDR solution modules 166 may include network security components that monitor and analyze network traffic in real-time, detect potential security threats, and provide an automated response to mitigate those threats. NDR solution modules 166 may use advanced machine learning and behavioral analysis techniques to identify abnormal patterns of network traffic, such as unusual traffic volume, suspicious communication between endpoints, or attempts to exploit vulnerabilities. NDR solution modules 166 may provide a comprehensive analysis of network activities across multiple cloud environments, including public and private clouds, and virtualized environments. NDR solution modules 166 may also help to identify and prioritize security incidents, reduce the time required to detect and respond to security threats, and provide greater visibility and control over network traffic.

The centralized security monitoring hub 150 may include network flow data repositories 168 that store data from the network traffic. A network flow data repository is a centralized repository of network flow data collected from various sources in a cloud server network. The network flow data repositories 168 are designed to store, process, and analyze large volumes of network flow data for security analysis, threat detection, and network performance optimization. In this context, network flow data may refer to metadata that describes the communication between devices in a network, such as source and destination IP addresses, port numbers, protocols, and timestamps. Further, the network flow data may be collected using network flow monitoring tools, such as flow analyzers or packet capture devices.

The centralized security monitoring hub 150 may include IP address credit score modules 172 that assign a credit score to a given IP address based on historical analysis of network flow data. The credit score modules 172 analyze data on network traffic to identify patterns of behavior, such as IP addresses that have been associated with malicious activity or suspicious patterns of activity. Another factor that the credit score modules 172 consolidate is IP reputation feeds from clients or service partners that have similar visibility into the network traffic. In effect, the credit score modules 172 quickly and accurately determine the trustworthiness of an IP address and identify IP addresses that are associated with malicious activity, based on a large dataset of IP addresses and their reputation based on past behavior.

Referring back to FIG. 1, the centralized security monitoring hub 150 may receive flow data and API (Application Programming Interfaces) traffic from client computers that create large and reliable datasets along with the records of the past control actions taken. This makes the system more effective, as it may learn from and build on the data from a large number of sources. In this context, “API traffic” refers to the traffic that is generated by applications that use APIs to communicate with other services. Some of the API traffic may come from workloads running in a trusted source, such as an internal network, and the source IP address may be one of the NAT (Network Address Translation) devices on the egress side of the network. With this information, security controls may be applied in a more effective manner and network traffic that is coming from a trusted source IP may be treated differently, as it is less likely to be malicious, versus traffic coming from an untrusted source. Further, by propagating this information through the network, the security solution may learn from and build on the data from a large number of sources without added latency or processing overhead.

In an embodiment, the system 100 may deploy the localized security enforcement module 114 and the hardware-based security component 152 in a daisy chain. Alternatively or in addition, one or more hardware-based security component 152 of the centralized security monitoring hub 150 may be deployed in a daisy chain.

Daisy chaining refers to the process of linking multiple monitoring or control devices in a series to create a chain, so that the output of one device becomes the input of the next device. The purpose of daisy chaining is to create a comprehensive network monitoring and control system by linking multiple devices together. Each device in the daisy chain provides a specific layer of protection and control over the network traffic. Further, daisy chaining allows for redundancy. In case one modules fails, the other modules still continue to provide the security service. By daisy chaining multiple security enforcement modules in the same place, it may provide improved security and compliance, and also better ability to handle large traffic volume and number of service instances. In operation, the multiple modules of the centralized security monitoring hub 150 may work in concert to provide a comprehensive and efficient security solution and protect the internal network and services from potential threats by allowing only authorized traffic through the network.

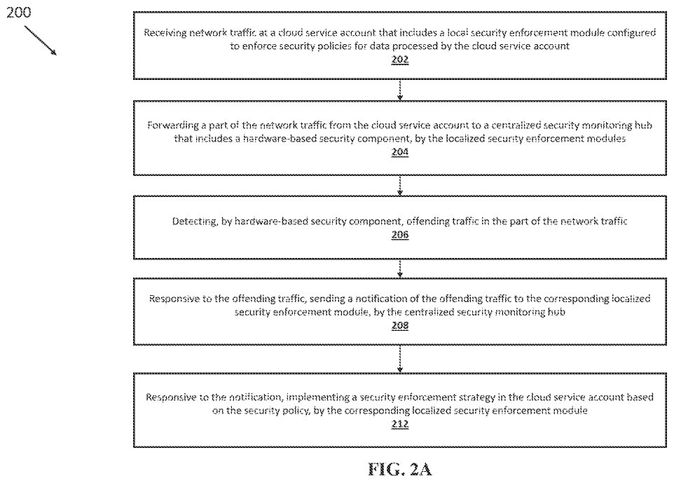

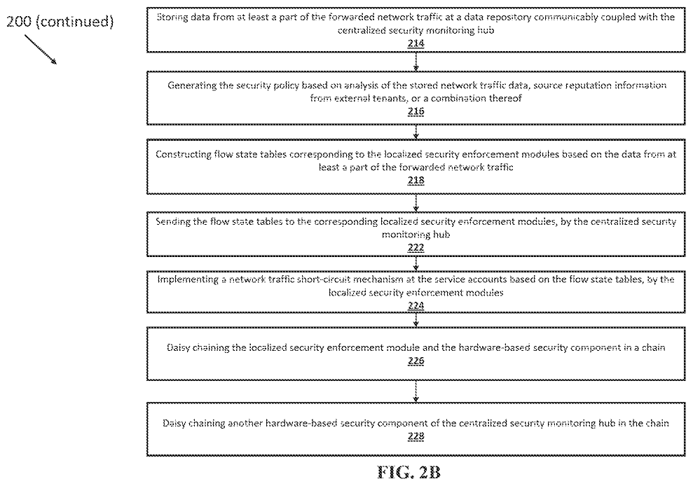

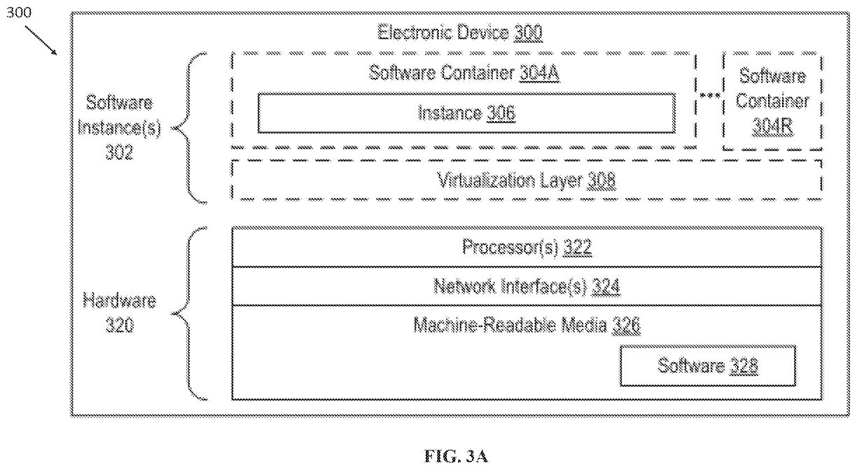

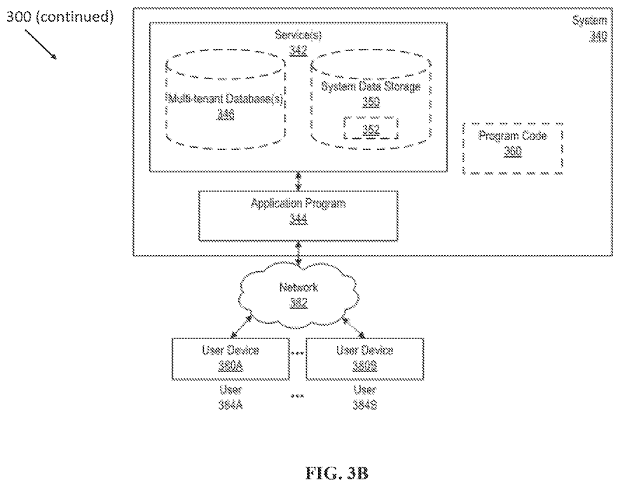

FIG. 2A is a flow diagram illustrating a computer-implemented method 200 for monitoring and control of a network traffic in a cloud server environment, as disclosed herein. The method 200 may be performed, for example, by a system as shown in FIG. 1 operating in conjunction with the hardware as shown in FIGS. 3A and 3B and/or by software executing on a server or distributed computing platform. Although the steps of method 200 are presented in a particular order, this is only for simplicity.

The computer-implemented method 200 may include, as in step 202, receiving network traffic at cloud service accounts that include corresponding local security enforcement modules. The local security enforcement modules are configured to enforce security policies for data processed by the cloud service account. At 204, at least a part of the network traffic from the cloud service account is forwarded by the localized security enforcement modules to a centralized security monitoring hub that includes hardware-based security components. At 206, any offending traffic in the part of the network traffic may be detected by the hardware-based security component. At 208, responsive to the offending traffic, a notification of the offending traffic may be sent to the corresponding localized security enforcement module. At 212, responsive to the notification, a security enforcement strategy may be implemented in the cloud service account based on the security policy.

FIG. 2B is a flow diagram illustrating a computer-implemented method 200 for monitoring and control of a network traffic in a cloud server environment, as disclosed herein. At 214, data from at least a part of the forwarded network traffic may be stored at a data repository communicably coupled with the centralized security monitoring hub. At 216, the security policy may be generated based on analysis of the stored network traffic data, source reputation information from external tenants, or a combination thereof. At 218, flow state tables corresponding to the localized security enforcement modules may be constructed, based on the data from at least a part of the forwarded network traffic. At 222, the flow state tables may be sent to the corresponding localized security enforcement. At 224, a network traffic short-circuit mechanism may be implemented at the service accounts by the localized security enforcement modules based on the flow state tables. The network traffic short-circuit mechanism may change an inline mode of the network traffic to an out-of-band mode. At 226, the localized security enforcement module and the hardware-based security components may be daisy chained in a chain. Further, at 228, multiple hardware-based security components of the centralized security monitoring hub may be daisy chained in the chain.

The hybrid cloud security approach of the present disclosure includes a centralized security monitoring hub and distributed localized security enforcement modules operating inter-dependently. The centralized security monitoring hub is typically focused on initial flow setup and configuration, whereas the localized security enforcement modules are focused on enforcing security and compliance policies. The localized security enforcement modules may use the information from the flow tables and the security policies configured in the centralized security monitoring hub, to make real-time decisions on whether to allow or block network traffic. The centralized security monitoring hub provides improved network security, increased visibility into network traffic, and centralized control over security policies and configurations. By consolidating security inspection into a single location or device, security threats are monitored and responded to in real-time. By distributing and localizing the security enforcement modules, tenants with large networks may protect against security threats while minimizing single points of failure, processing overhead and network latency.

In operation, development teams may manage their services and deploy new services quickly and easily, and still have security controls applied in a consistent, centralized manner. By having the localized security enforcement modules geographically close to the physical locations of the service instances, it reduces the latency and increases real-time enforcement of security policies performance. By having the centralized security monitoring hub in the same or close geographical region or location as the data center, it may further reduce the latency and ensure low-latency security control. In addition, the proposed solution may be scaled horizontally and vertically, allowing for better handling of increased traffic loads and increased number of service instances.

In terms of speed of performance, the centralized security hub 150 may be described as “slow path” and the localized security enforcement modules 114 may be described as “fast path”. The centralized security hub 150 is associated with inspection of the initial few packets through Transmission Control Protocol (TCP) or Transport Layer Security (TLS) sessions and also with inspection of the policy configuration to validate if a specific connection may be allowed or denied. The speed through the centralized security hub 150 is slow because the network traffic packets are forwarded to a different physical location and that adds latency to the overall flow. The slow path through the centralized security hub 150, however, provides details of policy definitions and other related information needed to make the security decisions. The centralized security hub 150, therefore, is also referred to as Policy Decision Point as per National Institute of Standards and Technology (NIST) architecture.

As a contrast, the localized security enforcement modules are associated with hash tables or look-up tables that perform the function of tracking the network connections locally at the service accounts, at high speed, through the fast path. Once a localized security enforcement module 114 allows a network connection for a specific TCP or TLS session, it typically constructs look-up tables that may be used for continued processing of the network traffic packets instead of re-evaluating the entire policy configuration. Subsequently, the look-up tables are transferred from the centralized security hub 150 to the localized security enforcement module 114. In operation, once a TCP or TLS session is established, no further network traffic packet for that session needs to be forwarded to the centralized security hub 150. The network traffic packets, instead, may be evaluated locally at the localized security enforcement modules 114, at a much faster pace, through the fast path.

One or more parts of the above implementations may include software. Software is a general term whose meaning may range from part of the code and/or metadata of a single computer program to the entirety of multiple programs. A computer program (also referred to as a program) includes code and optionally data. Code (sometimes referred to as computer program code or program code) includes software instructions (also referred to as instructions). Instructions may be executed by hardware to perform operations. Executing software includes executing code, which includes executing instructions. The execution of a program to perform a task involves executing some or all of the instructions in that program.

An electronic device (also referred to as a device, computing device, computer, etc.) includes hardware and software. For example, an electronic device may include a set of one or more processors coupled to one or more machine-readable storage media (e.g., non-volatile memory such as magnetic disks, optical disks, read only memory (ROM), Flash memory, phase change memory, solid state drives (SSDs)) to store code and optionally data. For instance, an electronic device may include non-volatile memory (with slower read/write times) and volatile memory (e.g., dynamic random-access memory (DRAM), static random-access memory (SRAM)). Non-volatile memory persists code/data even when the electronic device is turned off or when power is otherwise removed, and the electronic device copies that part of the code that is to be executed by the set of processors of that electronic device from the non-volatile memory into the volatile memory of that electronic device during operation because volatile memory typically has faster read/write times. As another example, an electronic device may include a non-volatile memory (e.g., phase change memory) that persists code/data when the electronic device has power removed, and that has sufficiently fast read/write times such that, rather than copying the part of the code to be executed into volatile memory, the code/data may be provided directly to the set of processors (e.g., loaded into a cache of the set of processors). In other words, this non-volatile memory operates as both long term storage and main memory, and thus the electronic device may have no or only a small amount of volatile memory for main memory.

In addition to storing code and/or data on machine-readable storage media, typical electronic devices may transmit and/or receive code and/or data over one or more machine-readable transmission media (also called a carrier) (e.g., electrical, optical, radio, acoustical or other forms of propagated signals—such as carrier waves, and/or infrared signals). For instance, typical electronic devices also include a set of one or more physical network interface(s) to establish network connections (to transmit and/or receive code and/or data using propagated signals) with other electronic devices. Thus, an electronic device may store and transmit (internally and/or with other electronic devices over a network) code and/or data with one or more machine-readable media (also referred to as computer-readable media).

Software instructions (also referred to as instructions) are capable of causing (also referred to as operable to cause and configurable to cause) a set of processors to perform operations when the instructions are executed by the set of processors. The phrase “capable of causing” (and synonyms mentioned above) includes various scenarios (or combinations thereof), such as instructions that are always executed versus instructions that may be executed. For example, instructions may be executed: 1) only in certain situations when the larger program is executed (e.g., a condition is fulfilled in the larger program: an event occurs such as a software or hardware interrupt, user input (e.g., a keystroke, a mouse-click, a voice command); a message is published, etc.); or 2) when the instructions are called by another program or part thereof (whether or not executed in the same or a different process, thread, lightweight thread, etc.). These scenarios may or may not require that a larger program, of which the instructions are a part, be currently configured to use those instructions (e.g., may or may not require that a user enables a feature, the feature or instructions be unlocked or enabled, the larger program is configured using data and the program's inherent functionality, etc.). As shown by these exemplary scenarios, “capable of causing” (and synonyms mentioned above) does not require “causing” but the mere capability to cause. While the term “instructions” may be used to refer to the instructions that when executed cause the performance of the operations described herein, the term may or may not also refer to other instructions that a program may include. Thus, instructions, code, program, and software are capable of causing operations when executed, whether the operations are always performed or sometimes performed (e.g., in the scenarios described previously). The phrase “the instructions when executed” refers to at least the instructions that when executed cause the performance of the operations described herein but may or may not refer to the execution of the other instructions.

Electronic devices are designed for and/or used for a variety of purposes, and different terms may reflect those purposes (e.g., user devices, network devices). Some user devices are designed to mainly be operated as servers (sometimes referred to as server devices), while others are designed to mainly be operated as clients (sometimes referred to as client devices, client computing devices, client computers, or end user devices; examples of which include desktops, workstations, laptops, personal digital assistants, smartphones, wearables, augmented reality (AR) devices, virtual reality (VR) devices, mixed reality (MR) devices, etc.). The software executed to operate a user device (typically a server device) as a server may be referred to as server software or server code), while the software executed to operate a user device (typically a client device) as a client may be referred to as client software or client code. A server provides one or more services (also referred to as serves) to one or more clients.

The term “user” refers to an entity (typically, though not necessarily an individual person) that uses an electronic device. Software and/or services may use credentials to distinguish different accounts associated with the same and/or different users. Users may have one or more roles, such as administrator, programmer/developer, and end user roles. As an administrator, a user typically uses electronic devices to administer them for other users, and thus an administrator often works directly and/or indirectly with server devices and client devices. The term “consumer” refers to another computer service that is running the reusable software components of the system o FIG. 1.

FIG. 3A is a block diagram illustrating an electronic device 300 according to some example implementations. FIG. 3A includes hardware 320 including a set of one or more processor(s) 322, a set of one or more network interfaces 324 (wireless and/or wired), and machine-readable media 326 having stored therein software 328 (which includes instructions executable by the set of one or more processor(s) 322). The machine-readable media 326 may include non-transitory and/or transitory machine-readable media. Each of the previously described clients and server components may be implemented in one or more electronic devices 300. In one implementation: 1) each of the clients is implemented in a separate one of the electronic devices 300 (e.g., in end user devices where the software 328 represents the software to implement clients to interface directly and/or indirectly with server components (e.g., software 328 represents a web browser, a native client, a portal, a command-line interface, and/or an application programming interface (API) based upon protocols such as Simple Object Access Protocol (SOAP), Representational State Transfer (REST), etc.)); 2) server components is implemented in a separate set of one or more of the electronic devices 300 (e.g., a set of one or more server devices where the software 328 represents the software to implement the framework for providing additional security to protected fields in protected views); and 3) in operation, the electronic devices implementing the clients and server components may be communicatively coupled (e.g., by a network) and may establish between them (or through one or more other layers and/or other services) connections for submitting requests to server components and returning responses to the clients. Other configurations of electronic devices may be used in other implementations (e.g., an implementation in which the client and server components are implemented on a single one of electronic device 300).

During operation, an instance of the software 328 (illustrated as instance 306 and referred to as a software instance; and in the more specific case of an application, as an application instance) is executed. In electronic devices that use compute virtualization, the set of one or more processor(s) 322 typically execute software to instantiate a virtualization layer 308 and one or more software container(s) 304A-304R (e.g., with operating system-level virtualization, the virtualization layer 308 may represent a container engine (such as Docker Engine by Docker, Inc. or rkt in Container Linux by Red Hat, Inc.) running on top of (or integrated into) an operating system, and it allows for the creation of multiple software containers 304A-304R (representing separate user space instances and also called virtualization engines, virtual private servers, or jails) that may each be used to execute a set of one or more applications; with full virtualization, the virtualization layer 308 represents a hypervisor (sometimes referred to as a virtual machine monitor (VMM)) or a hypervisor executing on top of a host operating system, and the software containers 304A-304R each represent a tightly isolated form of a software container called a virtual machine that is run by the hypervisor and may include a guest operating system; with para-virtualization, an operating system and/or application running with a virtual machine may be aware of the presence of virtualization for optimization purposes). Again, in electronic devices where compute virtualization is used, during operation, an instance of the software 328 is executed within the software container 304A on the virtualization layer 308. In electronic devices where compute virtualization is not used, the instance 306 on top of a host operating system is executed on the “bare metal” electronic device 300. The instantiation of the instance 306, as well as the virtualization layer 308 and software containers 304A-304R if implemented, are collectively referred to as software instance(s) 302.

Alternative implementations of an electronic device may have numerous variations from that described above. For example, customized hardware and/or accelerators might also be used in an electronic device.

FIG. 3B is a block diagram of a deployment environment according to some example implementations. A system 340 includes hardware (e.g., a set of one or more server devices) and software to provide service(s) 342, including server components. In some implementations the system 340 is in one or more datacenter(s). These datacenter(s) may be: 1) first party datacenter(s), which are datacenter(s) owned and/or operated by the same entity that provides and/or operates some or all of the software that provides the service(s) 342; and/or 2) third-party datacenter(s), which are datacenter(s) owned and/or operated by one or more different entities than the entity that provides the service(s) 342 (e.g., the different entities may host some or all of the software provided and/or operated by the entity that provides the service(s) 342). For example, third-party datacenters may be owned and/or operated by entities providing public cloud services.

The system 340 is coupled to user devices 380A-380S over a network 382. The service(s) 342 may be on-demand services that are made available to one or more of the users 384A-384S working for one or more entities other than the entity which owns and/or operates the on-demand services (those users sometimes referred to as outside users) so that those entities need not be concerned with building and/or maintaining a system, but instead may make use of the service(s) 342 when needed (e.g., when needed by the users 384A-384S). The service(s) 342 may communicate with each other and/or with one or more of the user devices 380A-380S via one or more APIs (e.g., a REST API). In some implementations, the user devices 380A-380S are operated by users 384A-384S, and each may be operated as a client device and/or a server device. In some implementations, one or more of the user devices 380A-380S are separate ones of the electronic device 300 or include one or more features of the electronic device 300.

In some implementations, the system 340 is any generic network interface management system that uses web interfaces and includes server application components, client application components and a browser extension. The system and method provide for authenticating the end user via a browser extension that needs to be available in the intended user's web browser. The input to the system and method is the information about the views and its specific fields or any other part that is rendered and need to be protected, as provided by the application owner. Typical generic examples are Java clients and applications, Python based frameworks, libraries for client applications implementing the logic described above.

In some implementations, the system 340 is any generic network interface management system that uses web interfaces and includes server application components, client application components and a browser extension. The system and method provide for authenticating the end user via a browser extension that needs to be available in the intended user's web browser. The input to the system and method is the information about the views and its specific fields or any other part that is rendered and need to be protected, as provided by the application owner. Typical generic examples are Java clients and applications, Python based frameworks, libraries for client applications implementing the logic described above.

Network 382 may be any one or any combination of a LAN (local area network). WAN (wide area network), telephone network, wireless network, point-to-point network, star network, token ring network, hub network, or other appropriate configuration. The network may comply with one or more network protocols, including an Institute of Electrical and Electronics Engineers (IEEE) protocol, a 3rd Generation Partnership Project (3GPP) protocol, a 4^{th} generation wireless protocol (4G) (e.g., the Long Term Evolution (LTE) standard, LTE Advanced, LTE Advanced Pro), a fifth generation wireless protocol (5G), and/or similar wired and/or wireless protocols, and may include one or more intermediary devices for routing data between the system 340) and the user devices 380A-380S.

Each user device 380A-380S (such as a desktop personal computer, workstation, laptop, Personal Digital Assistant (PDA), smartphone, smartwatch, wearable device, augmented reality (AR) device, virtual reality (VR) device, etc.) typically includes one or more user interface devices, such as a keyboard, a mouse, a trackball, a touch pad, a touch screen, a pen or the like, video or touch free user interfaces, for interacting with a graphical user interface (GUI) provided on a display (e.g., a monitor screen, a liquid crystal display (LCD), a head-up display, a head-mounted display, etc.) in conjunction with pages, forms, applications and other information provided by system 340. For example, the user interface device may be used to access data and applications hosted by system 340, and to perform searches on stored data, and otherwise allow one or more of users 384A-384S to interact with various GUI pages that may be presented to the one or more of users 384A-384S. User devices 380A-380S might communicate with system 340 using TCP/IP (Transfer Control Protocol and Internet Protocol) and, at a higher network level, use other networking protocols to communicate, such as Hypertext Transfer Protocol (HTTP), File Transfer Protocol (FTP), Andrew File System (AFS), Wireless Application Protocol (WAP), Network File System (NFS), an application program interface (API) based upon protocols such as Simple Object Access Protocol (SOAP), Representational State Transfer (REST), etc. In an example where HTTP is used, one or more user devices 380A-380S might include an HTTP client, commonly referred to as a “browser,” for sending and receiving HTTP messages to and from server(s) of system 340, thus allowing users 384A-384S of the user devices 380A-380S to access, process and view information, pages and applications available to it from system 340 over network 382.

In the above description, numerous specific details such as resource partitioning/sharing/duplication implementations, types and interrelationships of system components, and logic partitioning/integration choices are set forth in order to provide a more thorough understanding. Embodiments disclosed herein may be practiced without such specific details, however. In other instances, control structures, logic implementations, opcodes, means to specify operands, and full software instruction sequences have not been shown in detail since those of ordinary skill in the art, with the included descriptions, will be able to implement what is described without undue experimentation.

References in the specification to “one implementation,” “an implementation,” “an example implementation,” etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, and/or characteristic is described in connection with an implementation, one skilled in the art may know to affect such feature, structure, and/or characteristic in connection with other implementations whether or not explicitly described.

For example, the figure(s) illustrating flow diagrams sometimes refer to the figure(s) illustrating block diagrams, and vice versa. Whether or not explicitly described, the alternative implementations discussed with reference to the figure(s) illustrating block diagrams also apply to the implementations discussed with reference to the figure(s) illustrating flow diagrams, and vice versa. At the same time, the scope of this description includes implementations, other than those discussed with reference to the block diagrams, for performing the flow diagrams, and vice versa.

The detailed description and claims may use the term “coupled,” along with its derivatives. “Coupled” is used to indicate that two or more elements, which may or may not be in direct physical or electrical contact with each other, co-operate or interact with each other.

While the flow diagrams in the figures show a particular order of operations performed by certain implementations, such order is illustrative and not limiting (e.g., alternative implementations may perform the operations in a different order, combine certain operations, perform certain operations in parallel, overlap performance of certain operations such that they are partially in parallel, etc.).

While the above description includes several example implementations, the invention is not limited to the implementations described and may be practiced with modification and alteration within the spirit and scope of the appended claims. The description is thus illustrative instead of limiting.

What is claimed is:

1. A computer implemented method for monitoring and control of a network traffic in a cloud server environment, the method comprising:
receiving network traffic at a cloud service account comprising a corresponding local security enforcement module configured to enforce security policies for data processed by the cloud service account;
forwarding at least a part of the network traffic from the cloud service account to a centralized security monitoring hub, by the localized security enforcement modules, wherein the centralized security monitoring hub comprises a hardware-based security component;
detecting, by the hardware-based security component, offending traffic in the part of the network traffic, wherein the offending traffic comprises traffic from an unwanted source or with malicious content;
responsive to the offending traffic, sending a notification of the offending traffic to the corresponding localized security enforcement module, by the centralized security monitoring hub; and
responsive to the notification, implementing a security enforcement strategy in the cloud service account based on the security policy, by the corresponding localized security enforcement module.

2. The method of claim 1 further comprising:
storing data from at least a part of the forwarded network traffic at a data repository communicably coupled with the centralized security monitoring hub; and
generating the security policy based on analysis of the stored network traffic data, source reputation information from external tenants, or a combination thereof.

3. The method of claim 2, further comprising:
constructing flow state tables corresponding to the localized security enforcement modules based on the data from at least a part of the forwarded network traffic;
sending the flow state tables to the corresponding localized security enforcement modules, by the centralized security monitoring hub; and
implementing a network traffic short-circuit mechanism at the service accounts based on the flow state tables, by the localized security enforcement modules, the network traffic short-circuit mechanism configured to change an inline mode of the network traffic to an out-of-band mode.

4. The method of claim 3 further comprising daisy chaining the localized security enforcement module and the hardware-based security component in a chain.

5. The method of claim 4 further comprising daisy chaining at least one other hardware-based security component of the centralized security monitoring hub in the chain.

6. A system for monitoring and control of a network traffic in a cloud server environment, the system comprising:
a computer processor;
a cloud server application digitally connected with the computer processor, the cloud server application comprising:
a centralized security monitoring hub comprising a hardware-based security component, the centralized security monitoring hub configured to detect an offending traffic comprising traffic from an unwanted source or with malicious content;
a plurality of service accounts comprising local security enforcement modules configured to enforce security policies for data processed by the cloud service account;
a non-transitory machine-readable storage medium that provides instructions that, if executed by the processor, are configurable to cause the system to perform operations comprising:
receiving network traffic at a cloud service account;
forwarding at least a part of the network traffic from the cloud service account to the centralized security monitoring hub, by the localized security enforcement modules;
detecting, by the hardware-based security component, the offending traffic in the part of the network traffic;
responsive to the offending traffic, sending a notification of the offending traffic to the corresponding localized security enforcement module, by the centralized security monitoring hub; and
responsive to the notification, implementing a security enforcement strategy in the cloud service account based on the security policy, by the corresponding localized security enforcement module.

7. The system of claim 6 further comprising:
storing data from at least a part of the forwarded network traffic at a data repository communicably coupled with the centralized security monitoring hub; and
generating the security policy based on analysis of the stored network traffic data, source reputation information from external tenants, or a combination thereof.

8. The system of claim 7 further comprising:
constructing flow state tables corresponding to the localized security enforcement modules based on the data from at least a part of the forwarded network traffic;
sending the flow state tables to the corresponding localized security enforcement modules, by the centralized security monitoring hub; and
implementing a network traffic short-circuit mechanism at the service accounts based on the flow state tables, by the localized security enforcement modules, the network traffic short-circuit mechanism configured to change an inline mode of the network traffic to an out-of-band mode.

9. The system of claim 8 further comprising daisy chaining the localized security enforcement module and the hardware-based security component in a chain.

10. The system of claim 8 further comprising daisy chaining at least one other hardware-based security component of the centralized security monitoring hub in the chain.

11. A non-transitory machine-readable storage medium that provides instructions that, if executed by a processor, are configurable to cause said processor to perform operations comprising:
receiving network traffic at a cloud service account comprising a corresponding local security enforcement module configured to enforce security policies for data processed by the cloud service account;
forwarding at least a part of the network traffic from the cloud service account to a centralized security monitoring hub, by the localized security enforcement modules, wherein the centralized security monitoring hub comprises a hardware-based security component;
detecting, by the hardware-based security component, offending traffic in the part of the network traffic, wherein the offending traffic comprises traffic from an unwanted source or with malicious content;
responsive to the offending traffic, sending a notification of the offending traffic to the corresponding localized security enforcement module, by the centralized security monitoring hub; and
responsive to the notification, implementing a security enforcement strategy in the cloud service account based on the security policy, by the corresponding localized security enforcement module.

12. The non-transitory machine-readable storage medium of claim 11 further comprising:
storing data from at least a part of the forwarded network traffic at a data repository communicably coupled with the centralized security monitoring hub; and
generating the security policy based on analysis of the stored network traffic data, source reputation information from external tenants, or a combination thereof.

13. The non-transitory machine-readable storage medium of claim 12 further comprising:
constructing flow state tables corresponding to the localized security enforcement modules based on the data from at least a part of the forwarded network traffic;
sending the flow state tables to the corresponding localized security enforcement modules, by the centralized security monitoring hub; and
implementing a network traffic short-circuit mechanism at the service accounts based on the flow state tables, by the localized security enforcement modules, the network traffic short-circuit mechanism configured to change an inline mode of the network traffic to an out-of-band mode.

14. The non-transitory machine-readable storage medium of claim 13 further comprising daisy chaining the localized security enforcement module and the hardware-based security component in a chain.

15. The non-transitory machine-readable storage medium of claim 13 further comprising daisy chaining at least one other hardware-based security component of the centralized security monitoring hub in the chain.
